(19) United States
(12) Patent Application Publication
(10) Pub. No.: US 2021/0203821 A1
(43) Pub. Date: Jul. 1, 2021

(54) IMAGING DEVICE AND ELECTRONIC APPARATUS

(71) Applicant: BOE TECHNOLOGY GROUP CO., LTD., Beijing (CN)

(72) Inventors: Lei WANG, Beijing (CN); Lin ZHANG, Beijing (CN); Xiaoliang DING, Beijing (CN); Pengpeng WANG, Beijing (CN); Haisheng WANG, Beijing (CN)

(21) Appl. No.: 16/767,327

(22) PCT Filed: Dec. 16, 2019
(86) PCT No.: PCT/CN2019/125631

§ 371 Date: May 27, 2020

(30) Foreign Application Priority Data
Mar. 11, 2019 (CN) 201910180440.2

(51) Int. Cl. H04N 5/225; G03B 30/00; G02B 3/00

(52) U.S. Cl. CPC H04N 5/22541; H04N 5/2258; H04M 1/0264; G02B 3/0043; G03B 30/00

(57) ABSTRACT

An imaging device includes a lens array and an image sensor. The lens array includes a plurality of lens units, and is configured to provide a first lens sub-array and a second lens sub-array, the first lens sub-array includes a first lens unit of the lens units, the first lens unit and the image sensor are configured to have a first range of depth of field, the second lens sub-array includes a second lens unit of the lens units, the second lens unit and the image sensor are configured to have a second range of depth of field, the first depth range and the second depth range partially overlap, and a combined range of the first second ranges of depth of field is greater than each of the first range of depth of field and the second range of depth of field.

The application claims priority of the Chinese patent application No. 201910180440.2, filed on Mar. 11, 2019, the entire disclosure of which is incorporated herein by reference as part of the present application.

### TECHNICAL FIELD

Embodiments of the present disclosure relate to an imaging device and an electronic apparatus comprising the imaging device.

### BACKGROUND

A light field is a complete representation of a spatial light collection, and a real world can be visually reproduced by collecting and displaying the light field. A light field camera can acquire more complete light field information than an ordinary camera. An imaging part of the light field camera is generally composed of a micro-lens array and an image sensor. The micro-lens array can divide a light beam emitted by a same object point into discrete small light beams with different angles, and each of micro-lenses in the micro-lens array focuses a corresponding small light beam transmitting therethrough to a corresponding part of the image sensor. Each part of the image sensor receives the small light beam transmitting through the corresponding micro-lens to record a complete image having a specific orientation, so as to capture more complete light field information.

The light field camera can achieve a “photographing and then focusing” function. For example, for the light field camera with m (m is usually greater than 2, for example tens of) lenses, m original images can be acquired in one frame time. Then, the m original images are fused to acquire a desired final refocus image by a fusion refocus algorithm. The refocus focal plane of the resulting refocused image can be different depending on different algorithms

### SUMMARY

At least one embodiment of the present disclosure provides an imaging device comprising a lens array and an image sensor, wherein the lens array comprises a plurality of lens units, and is configured to provide at least a first lens sub-array and a second lens sub-array, the first lens sub-array comprises a first lens unit of the plurality of lens units, the first lens unit and the image sensor are configured to have a first range of depth of field, the second lens sub-array comprises a second lens unit of the plurality of lens units, the second lens unit and the image sensor are configured to have a second range of depth of field, the first range of depth of field and the second range of depth of field partially overlap with each other and a combined range of the first range of depth of field and the second range of depth of field is greater than each of the first range of depth of field and the second range of depth of field.

For example, according to an embodiment of the present disclosure, the first lens unit of the first lens sub-array has a first distance from the image sensor, and the second lens unit of the second lens sub-array has a second distance from the image sensor.

For example, according to an embodiment of the present disclosure, the first lens unit of the first lens sub-array has a first focal length, and the second lens unit of the second lens sub-array has a second focal length.

For example, according to an embodiment of the present disclosure, the first lens unit of the first lens sub-array has a first distance from the image sensor, and the second lens unit of the second lens sub-array has a second distance from the image sensor, the first lens unit of the first lens sub-array has a first focal length, and the second lens unit of the second lens sub-array has a second focal length.

For example, according to an embodiment of the present disclosure, the lens unit is a convex lens.

For example, according to an embodiment of the present disclosure, the first lens sub-array and the second lens sub-array are arranged regularly.

For example, according to an embodiment of the present disclosure, the plurality of lens units of the lens array are configured to make the focal length of each of the plurality of lens units be adjustable or the distance between each of the plurality of lens units and the image sensor be adjustable, so that the lens array respectively forms the first lens sub-array and the second lens sub-array in different time of periods.

For example, according to an embodiment of the present disclosure, the lens unit is a plurality of liquid crystal lens units, and the plurality of liquid crystal lens units are configured to make the focal length of each of the plurality of liquid crystal lens units be adjustable, so that the lens array respectively form the first lens sub-array and the second lens sub-array in different time of periods.

For example, according to an embodiment of the present disclosure, the imaging device further comprises a color filter array, wherein the color filter array comprises a plurality of color filters, each of the plurality of color filters corresponds to one of the plurality of lens units to filter light transmitting the one of the plurality of lens unit.

For example, according to an embodiment of the present disclosure, a back point for depth of field of the first range of depth of field is at infinity, and a back point for depth of field of the second range of depth of field is not at infinity.

For example, according to an embodiment of the present disclosure, an overlapping range of the first range of depth of field and the second range of depth of field is 0-100 mm

For example, according to an embodiment of the present disclosure, the image sensor comprises a plurality of sub-image sensors and the plurality of sub-image sensor correspond to the plurality of lens units one to one, so that each of the sub-image sensor is configured to receive incident light from one of the lens units for imaging.

For example, according to an embodiment of the present disclosure, the lens array is configured to also provide a third lens sub-array, the third lens sub-array comprises a third lens unit of the plurality of lens units, and the third lens unit and the image sensor are configured to have a third range of depth of field, the third range of depth of field at least partially overlaps one of the first range of depth of field or the second range of depth of field, a combined range of the first range of depth of field, the second range of depth of field, and the third range of depth of field is greater than any one or two of the first range of depth of field, the second range of depth of field, and the third range of depth of field.

At least one embodiment of the present disclosure also provides an electronic device comprising any of the imaging device as described above.

For example, according to an embodiment of the present disclosure, the electronic device comprises a housing and a display panel, the lens array and the display panel are disposed in the housing oppositely, and a part of the lens array is exposed to outside of the housing, and the image sensor is disposed inside the housing.

### BRIEF DESCRIPTION OF THE DRAWINGS

In order to more clearly explain the technical solutions of the embodiments of the present disclosure, the drawings required in the embodiments will be briefly introduced below. It should be understood that the following drawings only show some embodiments of the present disclosure, and therefore should not be regarded as a limitation to the scope. For those skilled in the art, other related drawings can be obtained based on these drawing, without any creative labor.

FIG. 1 illustrates a schematic diagram of a principle of an imaging device;

FIG. 2A illustrates a schematic diagram of a principle of a lens array and an image sensor of an imaging device according to another embodiment of the present disclosure;

FIG. 2B illustrates a schematic side view of an electronic device comprising the imaging device shown in FIG. 2A;

FIG. 2C illustrates a schematic diagram of a lens array, a filter array, and an image sensor of an imaging device according to another embodiment of the disclosure;

FIGS. 3A and 3B illustrate the image sensor in FIG. 2A;

FIGS. 4A, 4B, 4C, and 4D illustrate exemplary arrangements of lens arrays according to another embodiment of the present disclosure;

FIG. 5 illustrates a schematic diagram of a principle of a lens array and an image sensor of an imaging device according to another embodiment of the present disclosure;

FIG. 6 illustrates a schematic diagram of a principle of a lens array and an image sensor of an imaging device according to another embodiment of the present disclosure;

FIG. 7 illustrates a schematic diagram of a principle of a lens array and an image sensor of an imaging device according to another embodiment of the present disclosure;

FIG. 8 illustrates a schematic diagram of a principle of a lens array and an image sensor of an imaging device according to another embodiment of the present disclosure;

FIG. 9 illustrates a schematic perspective view of an electronic device comprising an imaging device according to an embodiment of the present disclosure;

FIG. 10A illustrates a schematic perspective view of an electronic device comprising an imaging device according to another embodiment of the present disclosure; and

FIG. 10B illustrates a schematic diagram of the lens array of the imaging device in FIG. 10A.

### DETAILED DESCRIPTION

Hereinafter, an imaging device and an electronic device comprising the same according to embodiments of the present disclosure will be described in detail with reference to the drawings. In order to make the purpose, technical solutions and advantages of the present disclosure more clear, the technical solutions in the embodiments of the present disclosure will be described clearly and completely in conjunction with the drawings of the embodiments of the present disclosure. Obviously, the described embodiments are some embodiments of the present disclosure, and are not all embodiments of the present disclosure.

Therefore, the following detailed description of the embodiments of the present disclosure provided in conjunction with the accompanying drawings is not intended to limit the scope of the claimed disclosure, but merely represents selected embodiments of the disclosure. Based on the embodiments of the present disclosure, all other embodiments obtained by those skilled in the art without any creative work fall within the protection scope of the present disclosure.

Unless otherwise defined by the context, the singular form comprises the plural form. Throughout the specification, the terms “comprising”, “having”, etc. are used herein to specify the described features, numbers, steps, operations, elements, components or combinations thereof, but do not exclude the presence or addition of one or more other features, numbers, steps, operations, elements, components, or combinations thereof.

In addition, even if terms comprising ordinal numbers such as “first” and “second” can be used to describe various components, these components are not limited by these terms, and these terms are only used to distinguish one element from other elements.

FIG. 1 illustrates an imaging device 10, for example, a light field camera, generally comprising a lens array 11 and an image sensor 12. Referring to FIG. 1, the lens array 11 comprises a plurality of lens units, and the image sensor 12 is disposed corresponding to the respective lens units. In operation, the respective light beams from a target imaging object (a tree in the figure) passes through each of the lens units, and then focuses on different parts of the image sensor 12 respectively. Therefore, the different parts of the image sensor 12 can record a complete image of the target imaging object from different orientations, and each of pixels of the different parts of the image sensor 12 records a spatial position of an object point (for example, referring to FIG. 1, the object points A, B, and C on the target imaging object).

In an imaging device having only a single lens array, the respective lens units of the single lens array and the image sensor are configured to have a single depth of field range. For any lens unit, the depth of field range obtained by combining it with the image sensor is limited. For example, the lens units of the single lens array and the image sensor have the depth of field of 20 cm to infinity when the focus point is on a focal plane, that is, a front point for depth of field is 20 cm from the lens, and the back point for depth of field is infinity. If the focus point is not on the focal plane but moves a certain distance in a direction towards the lens units, the back point for depth of field moves forward while the front point for depth of field moves forward. In this case, it cannot be clearly imaged at infinity. Therefore, it is difficult to increase the depth of field range of an imaging device having the single lens array due to limitations on the means, the space, or the cost.

Some embodiments of the present disclosure provide an imaging device comprising a lens array and an image sensor. In order to expand the depth of field of the imaging device, the lens array is configured to provide a first lens sub-array and a second lens sub-array in a spatial domain or a time domain. Lens units of the first lens sub-array and the image sensor are configured to have a first range of depth of field, lens units of the second lens sub-array and the image sensor are configured to have a second range of depth of field, and a combined range of the first range of depth of field and the second range of depth of field is larger than the first range of depth of field and also larger than the second range of depth of field. Therefore, the imaging device according to some embodiments of the present disclosure can expand the depth of field of the imaging device by providing the first lens sub-array and the second lens sub-array, so that the imaging device can refocus any object within the expanded depth of field range.

In some embodiments, the first range of depth of field and the second range of depth of field cannot overlap at all.

Alternatively, in other embodiments, the first range of depth of field and the second range of depth of field can partially overlap. For example, in the direction toward the image sensor, the front point for depth of field of the first range of depth of field is before the rear depth of field point of the second range of depth of field; for example, further, the rear depth of field point of the first range of depth of field is at infinity. Therefore, the combined range of the first range of depth of field and the second range of depth of field is continuous, so that the imaging device can refocus any object plane within the continuous depth of field range.

For example, in some embodiments, an overlapping range of the first range of depth of field and the second range of depth of field can be 0-100 mm, so that the depth of field range can be expanded as much as possible to improve an expansion efficiency. Here, when the overlapping range is equal to 0 mm, end points of the depth of field range coincide. In addition, the rear depth of field point of the first range of depth of field can be set at infinity and the rear depth of field point of the second range of depth of field can be set not at infinity, so that the depth of field range can also be expanded as much as possible.

The configuration of the imaging device according to various embodiments of the present disclosure is described in more detail below.

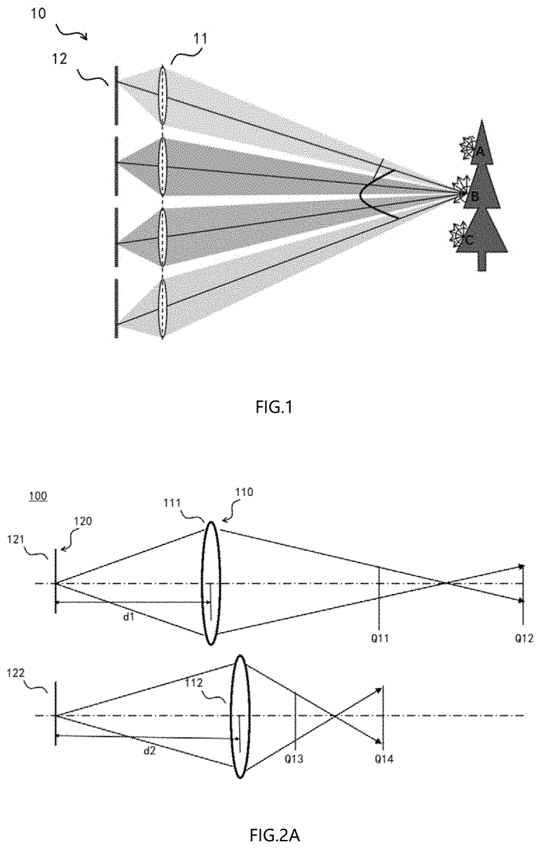

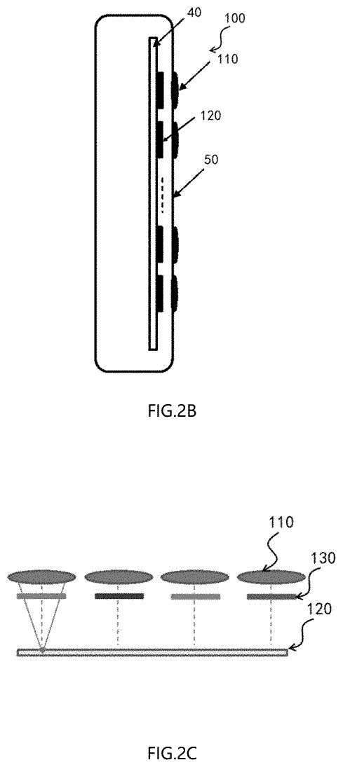

FIG. 2A illustrates a schematic diagram of a principle of an imaging device 100 according to an embodiment of the present disclosure. For example, the imaging device 100 can be implemented as a light field camera. As shown in FIG. 2A, the imaging device 100 comprises a lens array 110 and an image sensor 120, the lens array 110 comprises a plurality of lens units 111, 112, the plurality of lens units 111, 112 are arranged side by side with each other; the image sensor 120 comprises a plurality of sub-image sensors 121, 122, and the plurality of sub-image sensors 121, 122 are arranged side by side with each other.

In this embodiment, the lens array 110 comprises a first lens sub-array and a second lens sub-array. The first lens sub-array comprises at least one first lens unit 111, for example, a plurality of first lens units 111 (only one is shown in the figure), and the second lens sub-array comprises at least one second lens unit 112, for example, a plurality of second lens unit 112 (only one is shown in the figure). In this embodiment, specifications of the first lens unit 111 and the second lens unit 112 are the same. For example, the first lens unit 111 and the second lens unit 112 have the same focal length, size, and structure, and are solid lens units made of glass or resin materials, for example.

In addition, although each of the lens units is shown as a complete double-sided convex lens in FIG. 2A, it can be understood that each of the lens units can also be formed as a partially convex lens or a single-sided convex lens, which can also achieve the modulation of the transmission light. The following embodiments to be described are the same, which will be omitted.

The image sensor 120 comprises a first sub-image sensor array and a second sub-image sensor array, the first sub-image sensor array comprises at least one first sub-image sensor 121, and the second sub-image sensor array comprises at least one second sub-image sensor 122.

For example, the first sub-image sensor 121 and the second sub-image sensor 122 can be implemented by complementary metal oxide semiconductor (CMOS) devices or charge coupled devices (CCD). For example, each of the first sub-image sensor 121 or the second sub-image sensor 122 can comprise a pixel array and a detection circuit, and each of sub-pixels of the pixel array can comprise a photoelectric sensor device and a pixel drive circuit, etc. The detection circuit can comprise a read circuit, an amplification circuit, an analog-to-digital conversion circuit, etc., and thus photoelectric signals collected from the pixel array can be read and processed (for example, line by line) to obtain data corresponding to an image.

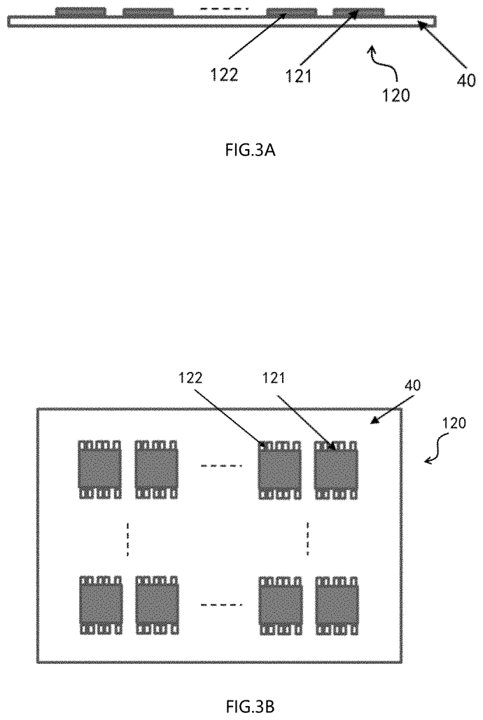

FIG. 2B illustrates a schematic side view of an exemplary electronic device comprising the imaging device 100 shown in FIG. 2A, and FIGS. 3A and 3B illustrate the image sensor 120 in FIG. 2A.

Referring FIGS. 2A, 2B, 3A, and 3B, the lens units 111, 112 in the lens array 110 correspond to the sub-image sensors 121, 122 in the image sensor 120 one to one. The light from the target imaging object passing through each of the lens units 111, 112 is focused to the corresponding sub-image sensors 121, 122 which overlap with each of the lens units 111, 112 in position in a light incident direction, and these sub-image sensors 121, 122 respectively form a complete image of the target imaging object. For example, the light from the target imaging object passing through the first lens unit 111 is focused on the first sub-image sensor 121 corresponding to the first lens unit 111, and the first sub-image sensor 121 forms a complete first image of the target imaging object; the light from the target imaging object passing through the second lens unit 112 is focused to the second sub-image sensor 122 corresponding to the second lens unit 112, and the second sub-image sensor 122 forms a complete second image of the target imaging object.

Because the respective lens units 111, 112 and the respective sub-image sensors 121, 122 corresponding to the respective lens units 111, 112 one to one are arranged in different positions, the complete images of the target imaging object formed by the respective sub-image sensors 121, 122 are complete images having different orientations. That is, the imaging device of this embodiment can acquire a plurality of the complete images of the target imaging object having different orientations in one photographing. Respective image sensors 121, 122 send the first image and the second image having different orientations to an image processing device (not shown in the figure, for example, an image processing chip) comprised in the electronic device, and then, the image processing device, for example after the photographing is completed, can fuse the first image and the second image by the fusion refocus algorithm to acquire a desired final refocus image.

Referring again to FIG. 2A, the first lens unit 111 has a first distance d1 from the corresponding first sub-image sensor 121, to have a first range of depth of field; the second lens unit 112 has a second distance d2 smaller than the first distance d1 from the second sub-image sensor 122 to have a second range of depth of field different from the first range of depth of field. The first distance d1 and the second distance d2 are configured so that the front point for depth of field Q13 of the second lens unit 112, the front point for depth of field Q11 of the first lens unit 111, the back point for depth of field Q14 of the second lens unit 112, and the back point for depth of field Q12 of the first lens unit 111 are sequentially arranged towards infinity. Therefore, the combined range of the first range of depth of field and the second range of depth of field is the continuous range between the front point for depth of field Q13 of the second lens unit 112 and the back point for depth of field Q12 of the first lens unit 111, which expands the depth of field range of the imaging device 100. That is, the first sub-image sensor 121 acquires a complete image of the target imaging object with a first range of depth of field, the second sub-image sensor 122 acquires a complete image of the target imaging object with a second range of depth of field. The plurality of complete images of the target imaging object having different orientations acquired by the respective sub-image sensors have an overall wider depth of field, so that the image processing device can fuse the original image with a wider depth of field by the fusion refocus algorithm to acquire the desired final refocus image with a wider depth of field.

In the present disclosure, the distance between the lens unit and the image sensor refers to the distance between an optical center of the lens unit and an imaging plane of the image sensor in a direction of a main optical axis of the lens.

In this embodiment, the first range of depth of field and the second range of depth of field are achieved by different distances between the different lens units 111 and 112 and the sub-image sensors 121 and 122. Because the specifications of the lens units 111 and 112 are the same, it is possible to reduce the manufacture cost and processing difficulty of the lens array.

In an example of this embodiment, as illustrated in FIGS. 2A to 2C and 3A to 3B, the respective sub-image sensors 121 and 122 are sub-image sensors which are independent from each other, and can be independently driven, for example.

For example, as illustrated in FIGS. 3A and 3B, the image sensor 120 comprises a plurality of sub-image sensors 121 and 122 and a base substrate 40, and the sub-image sensors 121 and 122 are disposed on the base substrate 40. For example, the respective sub-image sensors 121, 122 of the image sensor 120 can be disposed on the base substrate 40 by transferring, to reduce the manufacture cost; for another example, the respective sub-image sensors 121, 122 of the image sensor 120 can be disposed on the base substrate 40 by the surface mount technology (SMT). For example, the base substrate 40 can be a glass base substrate, a plastic base substrate, a ceramic base substrate, etc. The image sensor is obtained by using the glass base substrate, which can be compatible with the manufacture process of a general display device (for example, a liquid crystal display device or an organic light-emitting display device), to further reduce the manufacture cost. For example, circuit structures such as wires and contact pads (pads) are disposed on the base substrate 40, and the sub-image sensors 121 and 122 are bonded to the contact pads in various suitable ways (for example, soldering, conductive adhesive), etc., to implement the circuit connection.

In other embodiments of the present disclosure, the image sensor 120 can be configured as an integrated image sensor, and the sub-image sensors 121 and 122 are respectively different parts of the integrated image sensor. In this case, the light from the target imaging object passing through different lens units 111, 112 are respectively focused on different regions of the image sensor 120 corresponding to the different lens units 111, 112.

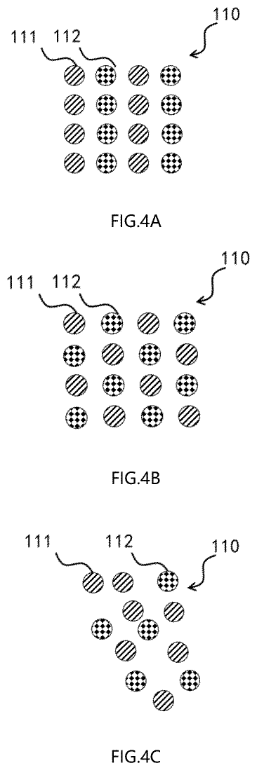

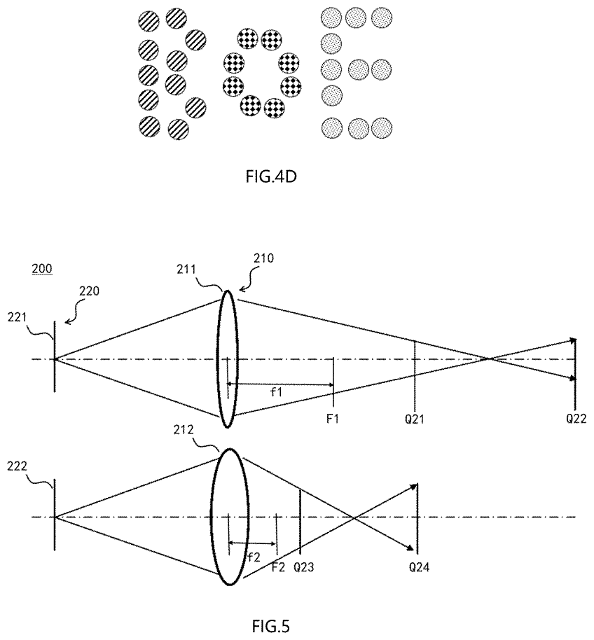

The respective lens sub-arrays of the lens array can be regularly arranged, for example, the lens sub-arrays are regularly, for example, periodically, arranged. For example, in this embodiment, as shown in FIG. 4A, all of the lens units are arranged in rows and columns to form a matrix form, in which the first lens units 111 and the second lens units 112 are arranged in rows and columns at intervals.

In some embodiments, as shown in FIG. 4B, all of the lens units are arranged in rows and columns to form a matrix form in which the first lens units 111 and the second lens units 112 are evenly spaced apart from each other in the row and column directions. The regularly arranged first lens sub-array and second lens sub-array facilitate to simplify the algorithm.

In some embodiments, the respective lens sub-arrays of the lens array can also be randomly arranged. As shown in FIG. 4C, the first lens units 111 and the second lens units 112 are randomly arranged in the row and column directions, and adjacent lens units are not aligned with each other.

In some embodiments, the respective lens sub-arrays of the lens array can also be arranged as a specific mark. In one example, as shown in FIG. 4D, the first lens sub-array is arranged as a letter B, the second lens sub-array is arranged as a letter O, and the third lens sub-array is arranged as a letter E. The arrangement of the specific marks facilitates to improve the appearance.

In some embodiments of the present disclosure, as illustrated in FIG. 2C, the imaging device 100 can further comprise a color filter array 130 comprising a plurality of color filers filtering the light passing through the respective lens units 111, 112 of the lens array, for example, a red color filter, a green color filter, and a blue color filter, so that the sub-image sensors corresponding to the respective lens units 111, 112 generate a monochrome image, and the resulting monochrome image will be processed subsequently. The color filter array 130 can be arranged in a Bayer array for the respective lens sub-arrays. The color filter array 130 can be arranged between the lens array 110 and the image sensor 120. Various color filters can be manufactured, for example, from colored resin materials.

FIG. 5 illustrates a schematic diagram of a principle of an imaging device 200 according to another embodiment of the present disclosure. As illustrated in FIG. 5, the imaging device 200 comprises a lens array 210 and an image sensor 220. The lens array 210 comprises a plurality of lens units 211 and 212 arranged side by side with each other; the image sensor 220 comprises a plurality of sub-image sensors 221 and 222 arranged side by side with each other.

In this embodiment, the lens array 210 comprises a first lens sub-array and a second lens sub-array. The first lens sub-array comprises a plurality of first lens units 211 (only one shown in the figure), and the second lens sub-array comprises a plurality of second lens units 212 (only one shown in the figure). The plurality of first lens units 211 and the plurality of second lens units 212 respectively have the same distance from the corresponding sub-image sensors 221 and 222. In one example, the lens array 210 is an integrated lens array, and the respective lens units of the lens array are connected to each other, for example, they are manufactured from the same resin film by a molding process, or manufactured from the same glass film by an etching process.

The image sensor 220 comprises a first sub-image sensor array and a second sub-image sensor array, the first sub-image sensor array comprises a plurality of sub-image sensors 221, and the second sub-image sensor array comprises a plurality of sub-image sensors 222.

Similar to the imaging device 100 described in FIGS. 2A to 3B, in the imaging device 200, the respective lens units 211, 212 correspond to the respective sub-image sensors 221, 222 one to one to form complete images of the target imaging object having different orientations, respectively.

Each of the first lens units 211 has a first focal length f1, so that the corresponding sub-image sensor 221 has a first range of depth of field, and each of the second lens units 212 has a second focal length f2 larger than the first focal length f1, so that the corresponding sub-image sensor 222 has a second range of depth of field different from the first range of depth of field, to expand the depth of field range of the imaging device 200. The first focal length f1 of the first lens unit 211 and the second focal length f2 of the second lens unit 212 are configured so that the front point for depth of field Q23 of the second lens unit 212, the front point for depth of field Q21 of the first lens unit 211, the back point for depth of field Q24 of the second lens unit 212 and the back point for depth of field Q22 of the first lens unit 211 are sequentially arranged towards infinity. Therefore, the combined range of the first range of depth of field and the second range of depth of field is the continuous range between the front point for depth of field Q23 of the second lens unit 212 and the back point for depth of field Q22 of the first lens unit 211, which expands the depth of field range of the imaging device 200.

Similarly, in at least one example, the imaging device 200 can further comprise a color filter array comprising a plurality of color filters filtering light passing through the respective lens units of the lens array, for example a red color filter, a green color filter, a blue color filter, etc.

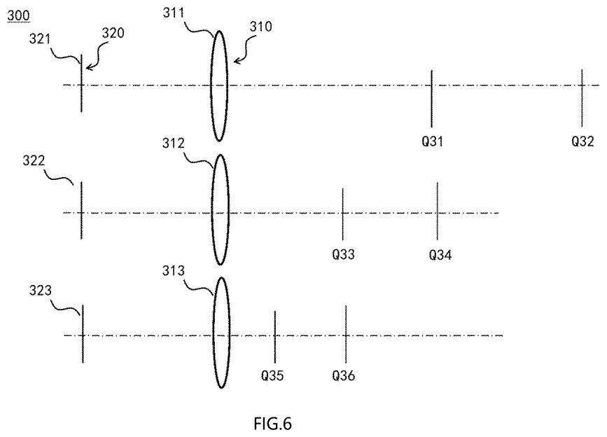

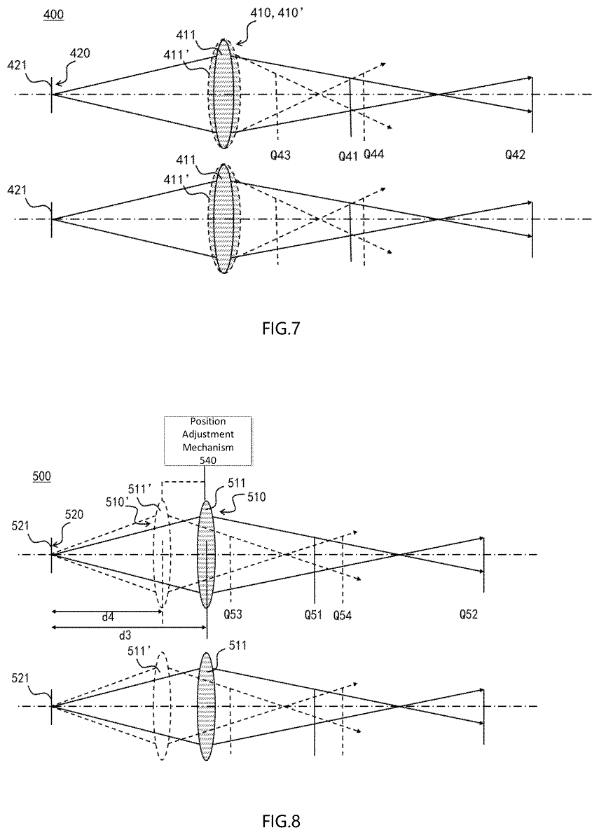

FIG. 6 illustrates a schematic diagram of a principle of an imaging device 300 according to another embodiment of the present disclosure. As shown in FIG. 6, the imaging device 300 comprises a lens array 310 and an image sensor 320. The lens array 310 comprises a plurality of lens units 311, 312, 313, and the plurality of lens units 311, 312, 313 are arranged side by side with each other; the image sensor 320 comprises a plurality of sub-image sensors 321, 322, 323, and the plurality of sub-image sensors 321, 322, and 323 are arranged side by side with each other.

In this embodiment, the lens array 310 comprises a first lens sub-array and a second lens sub-array, and further comprises a third lens sub-array.

The image sensor 320 comprises a first sub-image sensor array, a second sub-image sensor array, and a third sub-image sensor array, in which the first sub-image sensor array comprises a plurality of first sub-image sensors 321, the second sub-image sensor array comprises a plurality of second sub-image sensors 322, and the third sub-image sensor array comprises a plurality of third sub-image sensors 323.

Similar to the imaging device 100 described in FIGS. 2A to 3B, in the imaging device 300, the respective lens units 311, 312, 313 correspond to the respective sub-image sensors 321, 322, 323 one to one, to form complete images of the target imaging object having different orientations, respectively.

The first lens sub-array comprises a plurality of first lens units 311 (only one shown in the figure), each of the plurality of first lens units 311 has a front point for depth of field Q31 and a back point for depth of field Q32, and the back point for depth of field Q32 is infinity. The second lens sub-array comprises a plurality of second lens units 312 (only one shown in the figure), each of the plurality of second lens units 312 has a front point for depth of field Q33 and a back point for depth of field Q34. The third lens sub-array comprises a plurality of third lens units 313 (only one is shown in the figure), and each of the plurality of third lens units 313 has a front point for depth of field Q35 and a back point for depth of field Q36. The first, second and third lens unit 311, 312, and 313 and the corresponding image sensors 321, 322, and 323 are configured to have a first range of depth of field, a second range of depth of field, and a third range of depth of field, respectively, to expand the depth of field range of the imaging device.

In the direction toward the sub-image sensors 321, 322, 323, the front point for depth of field Q31 of the first lens unit 311 in the first lens sub-array is located before the back point for depth of field Q34 of the second lens unit 312 in the second lens sub-array, and the front point for depth of field Q33 of the second lens unit 312 in the second lens sub-array is located before the back point for depth of field Q36 of the plurality of third lens units 313 in the third lens sub-array. Therefore, the combined range of the first range of depth of field, the second range of depth of field, and the third range of depth of field is greater than any one or two of the first range of depth of field, the second range of depth of field, and the third range of depth of field, to expand the overall depth of field range of the imaging device.

In order to achieve the above-mentioned first range of depth of field, second range of depth of field, and third range of depth of field, the first lens unit 311, the second lens unit 312, and the third lens unit 313 can have different focal lengths. Additionally or alternatively, they can have different distances from the corresponding sub-image sensors 321, 322, and 323.

Similarly, in at least one example, the imaging device 300 can further comprise a color filter array comprising a plurality of color filters filtering light passing through the respective lens units in the lens array, for example, a red color filter, a green color filter, a blue color filter, etc.

It should be noted that the various embodiments of the present disclosure do not limit the number of the lens arrays in the imaging device having different depths of field with the image sensors, and it can be 2, 3, or more than 3. The lens array can be added as required to further expand the depth of field of the imaging device. As described above, in order to make the overall depth of field range be continuous, every two of the depth of field ranges of the plurality of lens arrays partially overlap with each other. In order to minimize the number of the lens arrays and increase the coverage and efficiency of each of the lens arrays under the same overall depth of field range, the overlapping range can be set not too large.

In other embodiments not shown, the lens array of the imaging device comprises a first lens sub-array and a second lens sub-array. The first lens sub-array comprises a plurality of first lens units, and the second lens sub-array comprises a plurality of second lens unit. The first lens unit has a first distance from the image sensor, the second lens unit has a second distance from the image sensor, the first lens unit has a first focal length, and the second lens unit has a second focal length, the first distance and the second distance are different and the first focal length and the second focal length are different, so that the combined range of the first range of depth of field and the second range of depth of field is larger than the first range of depth of field and the second range of depth of field, to expand the depth of field range of the imaging device. By adjusting the distance and focal length in combination, the different depth of field ranges can be configured more conveniently and flexibly.

In the imaging device of some embodiments of the present disclosure, because the first lens sub-array and the second lens sub-array are disposed in the spatial domain and the first lens sub-array and the second lens sub-array can be used for imaging simultaneously, compared with the first lens sub-array and the second lens sub-array formed in different time of periods, no requirement is limited on the imaging time. Also, the lens unit of the above lens array has a fixed focal length and a fixed position. Therefore, it is not necessary to dispose a specific mechanism to adjust the distance between the lens unit and the image sensor or to configure the lens unit to have an adjustable focal length to obtain an expanded depth of field. Such a lens unit and imaging device have a small cost.

In some other embodiments of the present disclosure, the imaging device can provide the image sensor with a first lens sub-array and a second lens sub-array in the time domain. That is, the imaging device can adjust the lens units of the lens array, so that the lens array forms the first lens sub-array and the second lens sub-array in different time of periods, respectively. The first lens sub-array and the second lens sub-array are formed respectively in different time of periods, which is beneficial to save space.

FIG. 7 illustrates a schematic diagram of a principle of an imaging device 400 according to another embodiment of the present disclosure. As shown in FIG. 7, the imaging device 400 comprises lens arrays 410, 410′ and an image sensor 420.

In this embodiment, the lens array 410, 410′ comprises a plurality of liquid crystal lens units 411, 411′. The image sensor 420 comprises a plurality of sub-image sensors 421. The plurality of liquid crystal lens units 411, 411′ correspond to the plurality of sub-image sensors 421 one to one. The focal lengths of the liquid crystal lens units 411, 411′ are configured to be adjustable.

For example, each of the liquid crystal lens units 411, 411′ comprises a liquid crystal layer and a plurality of liquid crystal control electrodes. The liquid crystal layer is sandwiched between two transparent base substrates, the plurality of liquid crystal control electrodes can be located (on the base substrate) on the same side of the liquid crystal layer, or a part of the liquid crystal control electrodes are located (on the base substrate) on one side and another part of the liquid crystal electrodes are located (on the base substrate) on the other side. When a predetermined voltage combination (driving voltage) is applied to the liquid crystal control electrodes, an electric filed distributed in predetermined form can be formed in the liquid crystal layer. The electric field can drive the liquid crystal molecules in the liquid crystal layer to deflect, to change the refractive index of the liquid crystal layer at different positions, so that the liquid crystal layer have a lens effect, to achieve the modulation of the light passing through the liquid crystal layer. Although FIG. 7 illustrates an example in which the liquid crystal lens is a double-sided convex lens, it should be understood that the contour shape of the liquid crystal lens unit itself may not be a double-sided convex lens.

The focal lengths of the liquid crystal lens units 411, 411′ are adjusted by applying different driving voltages to the liquid crystal lens units 411, 411′. By adjusting the focal lengths of the liquid crystal lens units 411, 411′, the lens array forms the first lens sub-array (as shown by the solid line in FIG. 7) and the second lens sub-array (as shown by the dot line in FIG. 7) in different time of periods.

As shown by the solid line in FIG. 7, at the first time point, the first lens units 411 of the formed first sub-lens array can have a first focal length, and, for example, correspond to a plurality of sub-image sensors 421 of the image sensor 420 one to one, to have a first range of depth of field, in which the front depth of filed point and the back point for depth of field of the first lens units 411 are Q41 and Q42.

As shown by the dot line in FIG. 7, at the second time point, the second lens units 411′ of the formed second lens sub-array can have a second focal length different from the first focal length, and also correspond to the plurality of sub-image sensors 421 of the image sensor 420 one to one, to have a second range of depth of field, in which the front depth of filed point and the back point for depth of field of the second lens unit 411′ are Q43 and Q44.

By appropriately arranging the first focal length and the second focal length, the front depth of filed point Q43 of the second lens units 411′, the front point for depth of field Q41 of the first lens units 411, the rear depth of filed point Q44 of the second lens units 411′ and the back point for depth of field Q42 of the lens units 411 are sequentially arranged towards infinity, so that the overall depth of field range of the imaging device 400 is expanded.

That is, the target imaging object can be imaged once at the first time point to acquire a set of complete images of the target imaging object having different orientations. Then, immediately after that, the target imaging object can be imaged once again at the second time point to acquire another set of complete images of the target imaging object having different orientations. Because the respective lens units 411, 411′ of the lens array have different depth of field ranges with the corresponding sub-image sensors 421 at the first time point and the second time point, the two sets of complete images acquired at the two different time points have different depth of field ranges. Therefore, the image processing device can fuse the original image acquired at the two different time points with an overall wider depth of field range, by the fusion refocus algorithm to acquire a desired final refocus image with a wider depth of field range.

Similarly, in at least one example, the imaging device 400 can further comprise a color filter array comprising a plurality of color filters filtering light passing through the respective lens units in the lens array, for example a red color filter, a green color filter, a blue color filter, etc. For example, the color filter array can be disposed between the lens array and the image sensor.

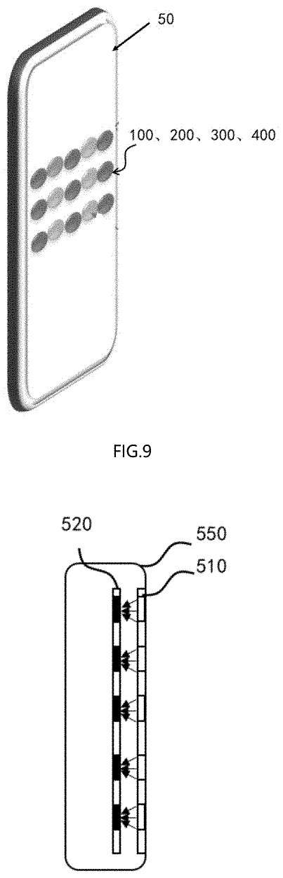

FIG. 8 illustrates a schematic diagram of a principle of an imaging device 400 according to another embodiment of the present disclosure. As shown in FIG. 8, the imaging device 500 comprises lens arrays 510, 510′ and an image sensor 520.

In this embodiment, the lens arrays 510, 510′ comprise a plurality of identical lens units 511, 511′. The image sensor 520 comprises a plurality of sub-image sensors 521. The plurality of lens units 511, 511′ correspond to the plurality of sub-image sensors 521 one to one.

The imaging device 400 further comprises a position adjustment mechanism 540 for adjusting the distance between the respective lens units 511, 511′ and the corresponding sub-image sensors 521. For example, the position adjustment mechanism 540 can be implemented in an appropriate manner, for example, a mechanical manner or a magnetic manner For example, the mechanical manner can comprise a motor, a gear, or a magnetic strain material element. That is, the distance between the lens units 511, 511′ and the sub-image sensors 521 is variable, so that the lens array 510, 510′ can respectively form the first lens sub-array (as shown by the solid line in FIG. 8) and the second lens sub-array (as shown by the dot line in FIG. 8) in different time of periods.

As shown by the solid line in FIG. 8, at the first time point, the first lens units 511 of the lens array 510 can have a first distance d3 from the corresponding sub-image sensors 521 to have a first range of depth of field, in which the front point for depth of field and the back point for depth of field of the first lens units 511 is Q51 and Q52.

As shown by the dot line in FIG. 8, at the second time point, because the position adjustment mechanism 540 adjusts the position of the lens unit 511′, 511, the second lens units 511′ of the lens array 510′ can have a second distance d4 different from the first distance d3 from the image sensors 521, to have a second range of depth of field, in which the front point for depth of field and the back point for depth of field of the second lens unit 511′ are Q53 and Q54.

The first distance d3 and the second distance d4 are arranged appropriately so that the front point for depth of field Q53 of the second lens units 511′, the front point for depth of field Q51 of the first lens units 511, the back point for depth of field Q54 of the second lens units 511′ and the back point for depth of field Q52 of the first lens units 511 are sequentially close to infinity, to expand the overall depth of field range of the imaging device 500.

Similarly, in at least one example, the imaging device 500 can further comprise a color filter array comprising a plurality of color filters filtering light passing through the respective lens units in the lens array, for example, a red color filter, a green color filters, a blue color filter, etc.

Of course, some other embodiments of the present disclosure can also be obtained by combining the above-mentioned embodiments, provided that they do not conflict with each other, so that the distance of the lens unit from the image sensor and the focal length of the lens unit can be comprehensively adjusted, and the embodiments of the present disclosure are not limited to this.

Some embodiments of the present disclosure also provide an electronic device comprising the imaging device of any embodiment of the present disclosure, for example, any imaging device described above. For example, the electronic device can be a mobile phone, a tablet computer, a laptop, etc. The embodiments of the present disclosure are not limited to this.

FIG. 9 illustrates a schematic perspective view of an exemplary electronic device according to an embodiment of the present disclosure, which comprises any of the above-mentioned imaging devices 100, 200, 300, 400, etc. The electronic device is, for example, a mobile phone, and the imaging devices 100, 200, 300, and 400 are, for example, disposed on the back of the mobile phone (that is, the side away from the user) as a rear camera. Of course, the implementation of the present disclosure is not limited to this. For example, the imaging devices 100, 200, 300, 400 can be designed as large as possible to acquire complete images of the target imaging object from more and larger orientations.

For example, referring to FIGS. 2A and 9, the electronic device comprises a display panel (not shown), a housing 50, an imaging device, and an image processing device (not shown). For example, a display surface of the display panel faces the user, that is, the display surface is located on a front of the electronic device; the imaging device is disposed on an opposite side to the display surface. The imaging device comprises a lens array and an image sensor. The lens array is disposed in the housing 50 of the electronic device and opposite to the display panel, and is exposed to the outside the housing 50 at the back of the electronic device, and the image sensor is disposed inside the housing 50 and adjacent to the lens array. The user can image the target object by the imaging device, and then execute the fusion refocus algorithm by the image processing device of the electronic device to form a final image on the display panel; the image processing device is, for example, an image processor or an image processing chip.

For example, the lens unit can be embedded in the housing 50 by a base (not shown), and the above-mentioned first distance and second distance can be determined by determining the position of the base.

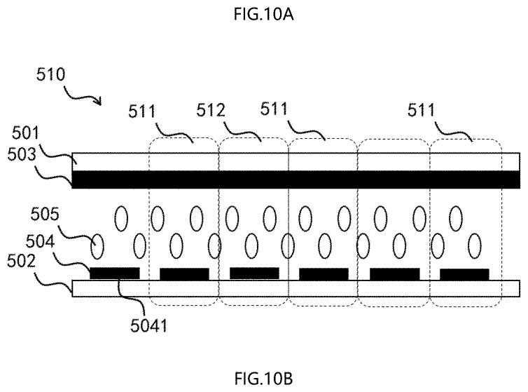

FIG. 10A illustrates a schematic perspective view of an exemplary electronic device according to another embodiment of the present disclosure, which comprises an imaging device 500. The electronic device is, for example, a mobile phone, and the imaging device 500 is, for example, disposed on the back of the mobile phone (that is, the side away from the user). Of course, the implementation of the present disclosure is not limited to this.

For example, referring to FIG. 10A, the electronic device comprises a display panel (not shown), a housing 550, an imaging device 500, and an image processing device (not shown). For example, the display surface of the display panel faces the user, that is, it is located on the front of the electronic device; the imaging device 500 is disposed on the opposite side of the display surface. The imaging device 500 comprises a lens array 510 and an image sensor 520.

FIG. 10B illustrates a schematic diagram of the lens array of the imaging device in FIG. 10A. In this embodiment, as shown in FIGS. 10A and 10B, the lens array 510 can be a liquid crystal lens array panel having a stacked structure. The liquid crystal lens array panel can be embedded in the housing 550 and disposed opposite to the display panel. The liquid crystal lens array panel comprises a first base substrate 501, a second base substrate 502, a first electrode layer 503 disposed on a side of the first base substrate 501 facing the second base substrate 502, a second electrode layer 504 disposed on a side of the second base substrate 502 facing the first base substrate 501, and a liquid crystal layer 505 located between the first electrode layer 503 and the second electrode layer 504. For example, the first electrode layer 503 and the second electrode layer 504 can be, for example, ITO transparent electrodes. The liquid crystal lens array panel can be divided into a plurality of liquid crystal lens units, for example, a plurality of first liquid crystal lens units 511 and a plurality of second liquid crystal lens units 512. In this embodiment, the first electrode layer 503 can be an integral common electrode, and the second electrode layer can comprise a plurality of second sub-electrodes 5041 that independently control the respective liquid crystal lens units 511, 512. That is, each of the liquid crystal lens units 511, 512 comprises a common first base substrate 503, a common first electrode layer 503, an independent second sub-electrode 504, a common liquid crystal layer 505, and a common second base substrate 502.

The scope of the present disclosure is not limited by the embodiments described above, but by the appended claims and their equivalents.

1. An imaging device, comprising a lens array and an image sensor,
wherein the lens array comprises a plurality of lens units, and is configured to provide at least a first lens sub-array and a second lens sub-array,
the first lens sub-array comprises a first lens unit of the plurality of lens units, the first lens unit and the image sensor are configured to have a first range of depth of field,
the second lens sub-array comprises a second lens unit of the plurality of lens units, the second lens unit and the image sensor are configured to have a second range of depth of field,
the first range of depth of field and the second range of depth of field partially overlap with each other and a combined range of the first range of depth of field and the second range of depth of field is greater than each of the first range of depth of field and the second range of depth of field.

2. The imaging device according to claim 1, wherein
the first lens unit of the first lens sub-array has a first distance from the image sensor,
the second lens unit of the second lens sub-array has a second distance from the image sensor and the second distance is different from the first distance.

3. The imaging device according to claim 1 wherein
the first lens unit of the first lens sub-array has a first focal length,
the second lens unit of the second lens sub-array has a second focal length different from the first focal length.

4. The imaging device according wherein
the lens unit is a convex lens.

5. The imaging device according to wherein
the first lens sub-array and the second lens sub-array are arranged regularly.

6. The imaging device according to claim 1, wherein
the plurality of lens units of the lens array are configured to make a focal length of each of the plurality of lens units be adjustable or a distance between each of the plurality of lens units and the image sensor be adjustable, so that the lens array respectively forms the first lens sub-array and the second lens sub-array in different time of periods.

7. The imaging device according to claim 1, wherein
the lens units are a plurality of liquid crystal lens units, and the plurality of liquid crystal lens units are configured to make a focal length of each of the plurality of liquid crystal lens units be adjustable, so that the lens array respectively forms the first lens sub-array and the second lens sub-array in different time of periods.

8. The imaging device according to claim 1, further comprising a color filter array, wherein the color filter array comprises a plurality of color filters, each of the plurality of color filters corresponds to one of the plurality of lens units to filter light transmitting the one of the plurality of lens unit.

9. The imaging device according to wherein
a back point for depth of field in the first range of depth of field is at infinity, and a back point for depth of field in the second range of depth of field is not at infinity.

10. The imaging device according to claim 1, wherein
an overlapping range of the first range of depth of field and the second range of depth of field is 0-100 mm.

11. The imaging device according to wherein
the image sensor comprises a plurality of sub-image sensors and the plurality of sub-image sensor correspond to the plurality of lens units one to one, so that each of the sub-image sensor is configured to receive incident light from one of the lens units for imaging.

12. The imaging device according to claim 1,
the lens array is configured to further provide a third lens sub-array,
the third lens sub-array comprises a third lens unit of the plurality of lens units, and the third lens unit and the image sensor are configured to have a third range of depth of field,
the third range of depth of field at least partially overlaps with one of the first range of depth of field or the second range of depth of field,
a combined range of the first range of depth of field, the second range of depth of field, and the third range of depth of field is greater than any one or two of the first range of depth of field, the second range of depth of field, and the third range of depth of field.

13. An electronic apparatus comprising the imaging device according to claim 1.

14. The electronic apparatus according to claim 13, wherein
the electronic device comprises a housing and a display panel,
the lens array and the display panel are disposed in the housing oppositely, and a part of the lens array is exposed to outside of the housing,
the image sensor is disposed inside the housing.
